(19) United States
(12) Patent Application Publication
(10) Pub. No.: US 2011/0040626 A1
(43) Pub. Date: Feb. 17, 2011

(54) METHOD AND SYSTEM FOR PROVIDING ADVERTISEMENT-BASED NAVIGATIONAL SERVICES

(75) Inventor: Zhijian Lin, Dublin, CA (US)

Correspondence Address: VERIZON;PATENT MANAGEMENT GROUP, 1320 North Court House Road, 9th Floor, ARLINGTON, VA, 22201-2909, US

(73) Assignee: VERIZON PATENT AND LICENSING INC., Basking Ridge, NJ (US)

(21) Appl. No.: 12/541,549

(22) Filed: Aug. 14, 2009

(51) Int. Cl. G06Q 30/00; G01C 21/36

(52) U.S. Cl. 705/14.63

(57) ABSTRACT

An approach is provided for advertisement-based navigational services. A route request is received from a user device for route directions. An advertisement request is generated for advertisement content. Location of the user device and routing information associated with the route directions are determined. The advertisement request is transmitted to an advertisement platform that selects an advertisement based on the location of the user device and the routing information. The selected advertisement is received. The selected advertisement along with the route directions are transmitted to the user device.

### BACKGROUND INFORMATION

The advent of wireless communication systems has served as a catalyst for the ubiquity of mobile computing devices, as well as the introduction of increasingly more complex services, such as navigational services. In conjunction with location-awareness technologies, like global positioning system (GPS) receivers, mobile computing devices and accompanying services now enable consumers to obtain real-time routing information, e.g., turn-by-turn directions, while en route to a predetermined destination. In order to facilitate terrestrial navigation, this routing information is typically presented with a topological depiction of a geographic area surrounding the destination, which may also be appended with various cartographic features, such as buildings, landmarks, roadways, signs, and the like. Other forms of enhanced content, such as estimated times of arrival (ETA), upcoming points of interest (POI), real-time traffic data, etc., may be provided as supplemental services. Associated subscription fees, however, are increasingly making these navigational services rather cost prohibitive to the average consumer.

Therefore, there is a need for an approach that can provide navigational services at reduced-cost without sacrificing quality or user experience.

### BRIEF DESCRIPTION OF THE DRAWINGS

Various exemplary embodiments are illustrated by way of example, and not by way of limitation, in the figures of the accompanying drawings in which like reference numerals refer to similar elements and in which:

FIG. 1 is a diagram of a system capable of providing advertisement-based navigational services, according to an exemplary embodiment;

FIG. 2 is a diagram of a navigational platform configured to provide subscribers with routing directions and advertisements, according to an exemplary embodiment;

FIG. 3 is a diagram of an advertisement platform configured to select advertisements, according to an exemplary embodiment;

FIG. 4 is a diagram of a mobile device, according to an exemplary embodiment;

FIG. 5 is a flowchart of a process for generating user profiles including user-defined advertisement policies, according to an exemplary embodiment;

FIG. 6 is a flowchart of a process for providing subscribers with routing directions embedded with one or more advertisements, according to an exemplary embodiment;

FIG. 7 is a flowchart of a process for selecting advertisements, according to an exemplary embodiment;

FIG. 8 is a flowchart of a process for presenting routing directions and advertisements to subscribers, according to an exemplary embodiment;

FIG. 9A is a diagram of a mobile device for presenting routing directions and advertisements, according to an exemplary embodiment;

FIG. 9B is a diagram of a mobile device display presenting updated routing directions in response to subscriber interaction with a location-based, interactive advertisement, according to an exemplary embodiment; and

FIG. 10 is a diagram of a computer system that can be used to implement various exemplary embodiments.

### DESCRIPTION OF THE PREFERRED EMBODIMENT

A preferred apparatus, method, and software for providing advertisement-based navigational services are described. In the following description, for the purposes of explanation, numerous specific details are set forth in order to provide a thorough understanding of the preferred embodiments of the invention. It is apparent, however, that the preferred embodiments may be practiced without these specific details or with an equivalent arrangement. In other instances, well-known structures and devices are shown in block diagram form in order to avoid unnecessarily obscuring the preferred embodiments of the invention.

Although various exemplary embodiments are described with respect to global positioning system (GPS) technology, it is contemplated that various exemplary embodiments are also applicable to other equivalent navigational and location determination technologies.

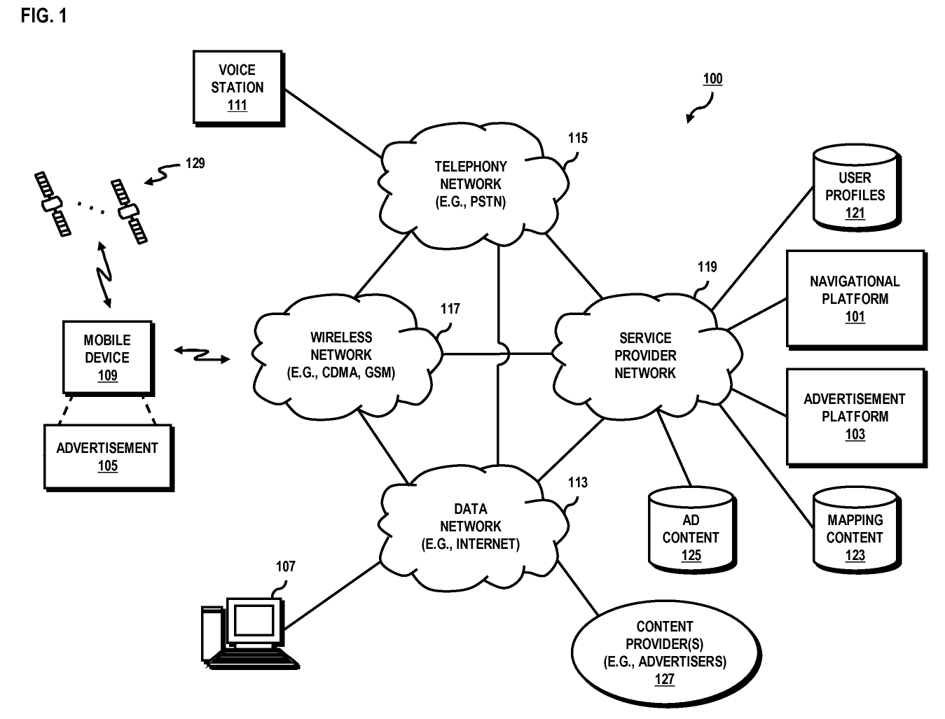

FIG. 1 is a diagram of a system capable of providing advertisement-based navigational services, according to an exemplary embodiment. For the purposes of illustration, system 100 including navigational platform 101 and/or advertisement platform 103 configured to provide navigational services including advertisements (e.g., advertisement 105) to one or more client (or user) devices (e.g., computing device 107, mobile device 109, and voice station 111) over one or more networks (e.g., data network 113, telephony network 115, and/or wireless network 117) is described with respect to service provider network 119. According to one embodiment, such services can be a managed service supplied by a service provider. While specific reference will be made thereto, it is contemplated that system 100 may embody many forms and include multiple and/or alternative components and facilities.

Traditionally, mapping and travel planning services (hereinafter collectively referred to as “navigational services”) have employed graphical and textual descriptions of locations and itineraries. Users often print or otherwise reproduce this information for use during a trip, e.g., for location-to-location navigational directions. Owners of portable GPS devices, such as GPS-enabled cellular devices, GPS-enabled positioning technologies, GPS-enabled navigation devices, and the like, often rely on this same information, but displayed to users via graphical user interfaces (GUI) or other like representations. In other instances, navigational services provide users with audio instructions in addition to the graphical and/or textual presentations. It is noted, however, that subscription fees and related taxes associated with these services can be rather expensive, if not totally cost prohibitive, to many consumers.

Service providers of, for example, conventional broadcast media channels, such as television and radio channels, often sequence their programming with advertisement segments in order to increase revenues and, at the same time, offer consumers various cost options (or subsidies) for accessing the media. For instance, a network television provider may supply consumers with free broadcast media by selling slotted shares of “airtime” to advertisers who are then able to reach these consumers via mass-marketing campaigns. Providers of subscription-based programming services, such as cable television or “on-demand” media service providers, offer consumers advertisement-free (or, at least, advertisement-reduced) programming, albeit contingent upon consumer acceptance of at least one fee schedule.

Therefore, the approach according to certain embodiments of system 100 stems from the recognition that by deploying advertisement-based navigational services, whereby subscribers can negotiate to receive navigational information (e.g., routing directions) along with advertisements (or advertisement content) in exchange for subsidized subscription fees, enables service providers to expand their range of prospective consumers, encourage existing subscribers to increase service usage, and obtain supplemental sources of revenue. Certain other embodiments of system 100 stem from the recognition that enabling subscribers to seamlessly define and customize one or more advertisement policies for receiving navigational information along with advertisements, permits advertisers to better target advertisement content to consumers and, thereby, provides an efficient and convenient technique to enhance and personalize the navigational experiences of these consumers. Additional embodiments of system 100 stem from the recognition that providing consumers with location (or proximity)-based advertisements serves as an effective technique for targeting advertisements to consumers, not to mention, increasing the likelihood that consumers will be responsive to the campaigns. To this end, other embodiments of system 100 stem from the recognition that deploying interactive advertisements, whereby subscribers can request and obtain routing directions to destinations related to the advertisements, also increases the likelihood that consumers will be responsive to the conveyed advertisements.

According to various embodiments, system 100 introduces advertisement-based navigational services, whereby users (or subscribers) can access navigational platform 101 via one or more client devices (e.g., computing device 107, mobile device 109, or voice station 111) to register to and receive authentication information for the advertisement-based navigational services of system 100, as well as to create, customize, and manage one or more user-defined advertisement policies enabling subscribers to opt-in or opt-out of receiving navigational information (e.g., routing directions, itineraries, points of interest (POI), estimated times of arrival (ETA), traffic information, weather information, etc.) along with advertisements (or advertisement content) in exchange for subscription subsidies to the advertisement-based navigational services of system 100. If a particular user decides to opt-in to receiving advertisements, an advertisement policy associated with that user may be created to include one or more additional parameters (or criteria) governing the “who,” “what,” “when,” “where,” and “how” advertisements are to be received, such as various parameters defining amount (e.g., certain number of advertisements per hour, day, week, etc.), frequency of presentation (e.g., continuously, periodically, on-demand, etc.), location (e.g., present advertisements associated with locations within “X” amount of distance, within “Y” amount of travel time, etc.), mode (e.g., advertisements presented as audio, video, text, graphic, etc., content), marketplaces (e.g., basic materials, capital goods, energy, financial, healthcare, services, technology, transportation, utilities, etc.), and the like for receiving advertisements, as well as any other suitable criteria, such as one or more “whitelists” specifying permissible advertisers, advertisement sources, advertisement content, etc., that can be targeted to the subscriber and one or more “blacklists” specifying impermissible (or objectionable) advertisers, advertisement sources, advertisement content, etc., that should not be received. In various exemplary embodiments, these parameters, criteria, etc., may be utilized by one or more of navigational platform 101, advertisement platform 103 and/or user devices 107-111 to request, select, and/or present advertisements (e.g., advertisement 105) that are targeted to the subscribers.

To this end, the aforementioned user-defined advertisement policies may be stored to one or more corresponding user profiles including other information related to the subscribers of the advertisement-based navigational services of system 100, such as user profile information defining subscription information (e.g., account numbers, usernames, passwords, security questions, monikers, etc.), subscriber demographics (e.g., age, gender, ethnicity, location of residence, zip code, school district, community, socioeconomic status, religion, marital status, ownerships, languages, mobility, life cycles, etc.), location (e.g., spatial positioning, latitude, longitude, elevation, etc.), group/organizational affiliations (e.g., political), memberships, interests, buddies, friends, cohorts, system configurations, policies, associated users/devices, etc., as well as any other like personal information. As such, this other information may also be utilized to provide subscribers with targeted advertisements and, as a result, subscribers may also define permissible boundaries for the use and/or dissemination of their user profile information, whether in connection with targeting advertisements to the subscribers or whether in connection with some other conceivable purpose.

According to particular embodiments, users (or subscribers) may access navigational platform 101 via a portal (not illustrated), such as a voice portal or a web portal. In an exemplary embodiment, a networked application for implementing the portal is deployed via navigational platform 101; however, it is contemplated that another facility or component of system 100, such as a frontend, middleware, or backend server, may deploy the application and, consequently, interface with navigational platform 101. In this manner, the portal may include or provide users with the ability to access, configure, manage, and store user profiles to, for example, user profiles repository 121 or any other suitable storage location or memory of (or accessible to) system 100, such as one or more memories (not shown) of user devices 107-111, navigational platform 101, or advertisement platform 103. In this manner, the portal may enable subscribers to provide corresponding authentication information and, subsequently, permit them to create, customize, and manage one or more user-defined (i.e., individualized) advertisement policies via one or more user interfaces, e.g., graphical user interfaces (GUI), implemented via the portal and/or user devices 107-111. Likewise, the portal may allow users to construct the aforementioned user profiles that, in exemplary embodiments, include the one or more user-defined advertisement policies, which may be utilized to dynamically select, retrieve, and transmit advertisements (or advertisement content) along with navigational information (e.g., routing directions) to subscribers. It is noted that the selection of advertisements may also be based on (or correlated with) travel information (e.g., planned routes, schedules, etc.) and/or real-time spatial positioning information corresponding to the general location or specific position of subscribers. In certain instances, one or more conditional variables, e.g., routing directions being executed, upcoming POIs, etc., may be utilized to dynamically select, retrieve, and transmit advertisements, such as advertisement 105, to users. It is also contemplated that the aforementioned polices, parameters, variables, information, etc., that are utilized to dynamically select, retrieve, and transmit advertisements to users may also be utilized to rank the suitability of advertisements for potential subscribers. Consequently, users may be dynamically provided with advertisements that may be, according to certain exemplary embodiments, specifically targeted to users, when those users are, for instance, en route to one or more predetermined destinations.

Navigational platform 101 may also be configured to enable subscribers to request and receive various forms of navigational information (or content) corresponding to, for example, one or more geographic areas (e.g., cities, states, countries, continents, etc.) and/or itineraries, such as information utilized to present users with (or corresponding to) one or more geographic maps (e.g., first-person perspective viewpoints, third-person perspective viewpoints, actual satellite depictions, artistic renditions, etc.), POIs, routing directions (e.g., boating, driving, flying, walking, etc.), ETAs, landmarks, traffic information, road conditions, weather, etc. As such, navigational platform 101 may utilize content retrieved (or received) from one or more repositories including mapping content, such as mapping content repository 123, for providing subscribers with these various forms of navigational information. It is noted that the mapping content of repository 123 may be stored thereto in one or more embedded, correlated, combined, and/or sequenced fashions or may be embedded, correlated, combined, and/or sequenced by navigational platform 101. It is further noted that navigational platform 101 may embed, correlate, combine, and/or sequence advertisements with navigational information before and/or during transmission to subscribers.

According to particular embodiments, navigational platform 101 (or, in certain instances, user devices 107-111) may be configured to generate one or more advertisement requests for obtaining advertisement content from advertisement platform 103, an advertisement (or ad) content repository 125, or from one or more third-party content providers (e.g., advertisers) 127. As such, requests for advertisement content may be generated based on and/or configured to include navigational information (e.g., predetermined routing directions), spatial positioning (or location) of subscribers, and/or user profile information, such as one or more parameters, criteria, information etc., of a user-defined advertisement policy. In this manner, selection of advertisements by, for example, advertisement platform 103 may be based on the requests for advertisement content, navigational information, spatial positioning, and/or user profile information. It is noted that selected advertisements (or advertisement content) may be transmitted to navigational platform 101 to provide to one or more of user devices 107-111 along with (or as an addendum to) navigational information. As such, it is also contemplated that advertisement platform 103, ad content repository 125, and/or content providers 127 may be signaled by navigational platform 101 or user devices 107-111 to directly provide one or more of user devices 107-111 with the advertisements, such as advertisement 105.

As previously mentioned, platforms 101 or 103 may be configured to dynamically provide subscribers with navigational and/or advertisement information based on real-time spatial positioning information corresponding to the location of a user, i.e., the location of, for example, a mobile device of the user, e.g., mobile device 109. The spatial position (or location) of a mobile device 109 may be determined through conventional satellite positioning system (SPS) technology, such as GPS technology; however, any suitable navigational or location determination technology may be utilized, such as advanced forward link trilateration (A-FLT), assisted-GPS (A-GPS), enhanced cellular identification (CELL-ID), wireless area network (WLAN) positioning, etc. As is well known, SPS technology utilizes a constellation 129 of satellites that transmit signals to receivers (not shown) of, for example, one or more mobile devices 109, so that the receivers may determine corresponding spatial positions (or locations), speeds, directions, and/or timing for the mobile devices 109. Mobile devices 109 report this information to navigational platform 101 and/or advertisement platform 103 to facilitate the rendering and dynamic provisioning of routing directions and advertisement content (e.g., advertisement 105), among other advertisement-based navigational services extended via platforms 101 and 103. It is also noted that platforms 101 and/or 103 may “poll” or receive positioning information from mobile devices 109 in real-time, so as to provide presence service features to mobile devices 109. As such, the location of, for instance, mobile device 109 may be detected without mobile device 109 having to initiate a phone call or other like communication session. Thus, navigational platform 101 and/or advertisement platform 103 may provide users with dynamic navigational information (e.g., routing directions, etc.) and/or advertisement content based on (or correlated to) the presence (or physical location) of users. It is also noted that the spatial positioning of subscribers may be stored to user profiles repository 121 or any other suitable storage location or memory of (or accessible to) system 100.

As seen in FIG. 1, service provider network 119 enables client devices 107-111 to access the advertisement-based navigational services of system 100 through one or more of platforms 101 and 103 via one or more of networks 113-117. Networks 113-119 may be any suitable wireline and/or wireless network. For example, telephony network 115 may include a circuit-switched network, such as the public switched telephone network (PSTN), an integrated services digital network (ISDN), a private branch exchange (PBX), or other like network. Wireless network 117 may employ various technologies including, for example, code division multiple access (CDMA), enhanced data rates for global evolution (EDGE), general packet radio service (GPRS), global system for mobile communications (GSM), Internet protocol multimedia subsystem (IMS), universal mobile telecommunications system (UMTS), etc., as well as any other suitable wireless medium, e.g., microwave access (WiMAX), wireless fidelity (WiFi), satellite, and the like. Meanwhile, data network 113 may be any local area network (LAN), metropolitan area network (MAN), wide area network (WAN), the Internet, or any other suitable packet-switched network, such as a commercially owned, proprietary packet-switched network having voice over internet protocol (VoIP) capabilities, e.g., a proprietary cable or fiber-optic network. Although depicted as separate entities, networks 113-119 may be completely or partially contained within one another, or may embody one or more of the aforementioned infrastructures. For instance, service provider network 119 may embody circuit-switched and/or packet-switched networks that include facilities to provide for transport of circuit-switched and/or packet-based communications. It is further contemplated that networks 113-119 may include components and facilities to provide for signaling and/or bearer communications between the various components or facilities of system 100. In this manner, networks 113-119 may embody or include portions of a signaling system 7 (SS7) network, or other suitable infrastructure to support control and signaling functions.

Accordingly, the conjunction of networks 113-119 may be adapted to provide navigational information (e.g., routing directions) and/or advertisement information (e.g., advertisement 105), as well as enable user access to navigational platform 101. As such, user devices 107-111 may include any customer premise equipment (CPE) capable of sending and/or receiving information over one or more of networks 113-119. For instance, voice station 111 may be any suitable plain old telephone service (POTS) device, facsimile machine, etc., while mobile device 109 may be any cellular phone, radiophone, satellite phone, smart phone, wireless phone, or any other suitable mobile device, such as a personal digital assistant (PDA), pocket personal computer, tablet, customized hardware, etc. Further, computing device 107 may be any suitable computing device, such as a VoIP phone, skinny client control protocol (SCCP) phone, session initiation protocol (SIP) phone, IP phone, personal computer, softphone, workstation, terminal, server, etc. Even though only a limited number of user devices 107-111 are illustrated, it is contemplated that system 100 can support a plurality of user devices 107-111.

Accordingly, subscribers may experience navigational information (e.g., routing directions) and/or advertisement content via one or more presentation interfaces (e.g., audio, visual, and/or tactile interfaces) of one or more user devices, such as user devices 107-111. For example, users may be presented with one or more graphical depictions or textual explanations corresponding to routing directions, as well as prompted with auditory advertisement information, such as advertisement 105, in a continuous, periodic, or on-demand fashion. It is noted that visual output may be provided by at least one digital image or sequencing of digital images, whereas auditory output may be provided in the form of audio (or acoustic sounds), which may be associated with at least a portion of the visual output. Further, it is contemplated that supplementary auditory, textual, and/or graphical content may be provided either overlaid on a visual presentation or provided as an addendum thereto.

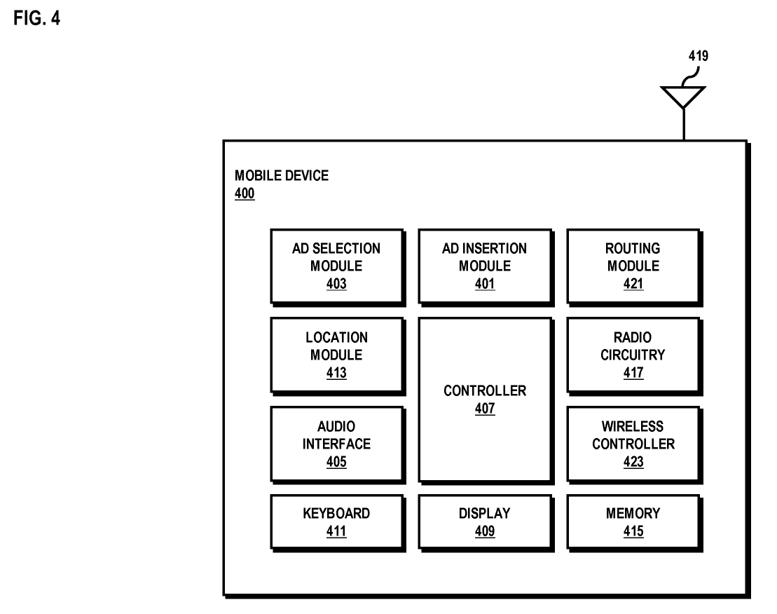

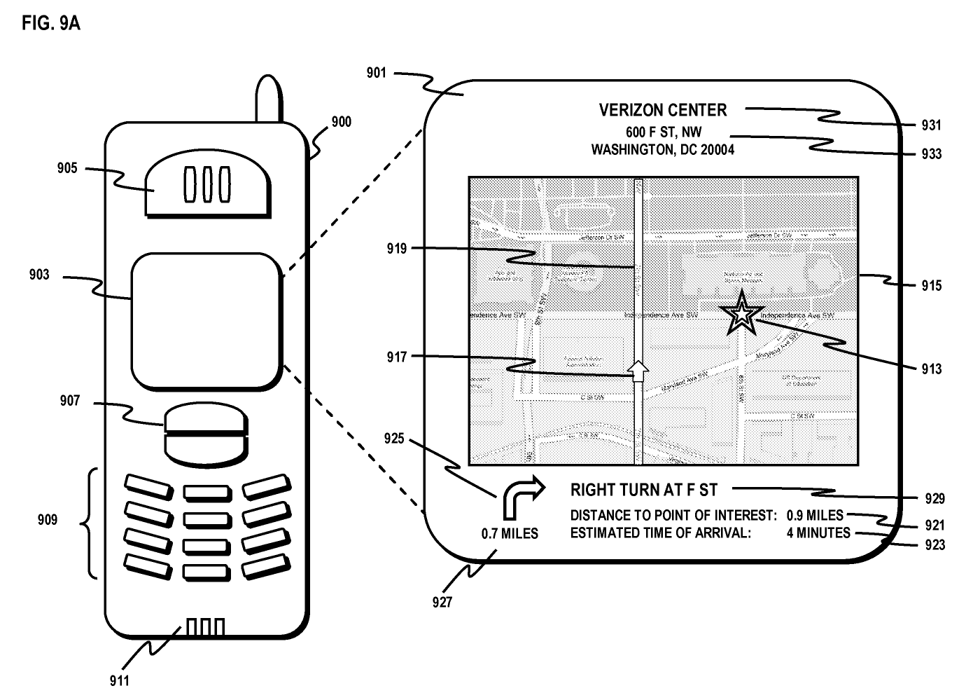

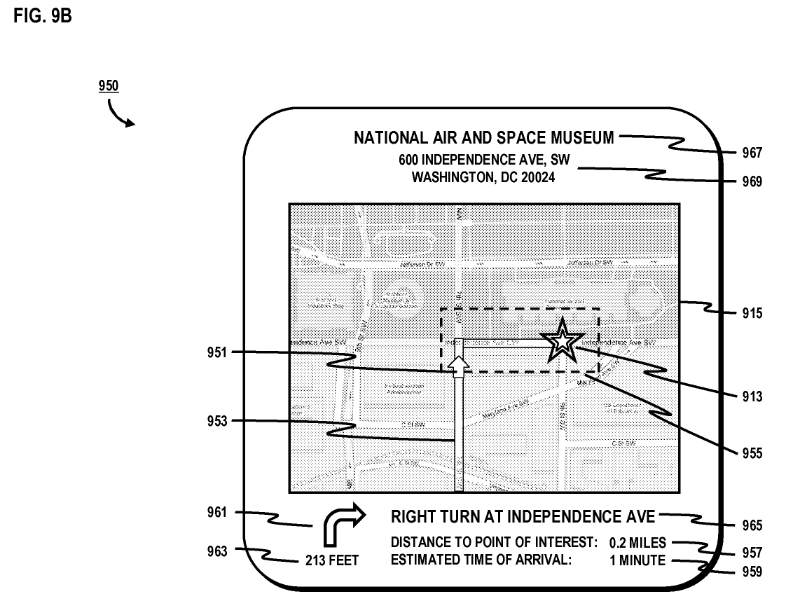

To this end, user devices 107-111 may include one or more client programs (not shown) that operate thereon for providing the advertisement-based navigational services of system 100; however, it also is contemplated that these (or other) client programs may be executed via navigational platform 101 and, thereby, made accessible to users via user devices 107-111. In one embodiment, these client programs may relate to one or more graphical user interfaces (GUI) configured to control the presentation of navigational and/or advertisement information, such as real-time routing directions embedded with, for instance, periodic advertisement content. To this end, the GUIs may be configured to facilitate the acquisitioning, exchanging, managing, sharing, storing, and/or updating of navigational information and/or advertisement information via user devices 107-111. In various instances, network browser applications may be provided for accessing similar applications made available by, for example, navigational platform 101. An exemplary mobile device 109 is explained in more detail in conjunction with FIG. 4, whereas exemplary GUIs capable of execution on mobile device 109 are more fully described with respect to FIGS. 9A and 9B.

As previously mentioned, user profiles repository 121 stores user profiles at least including one or more user-defined advertisement policies, mapping content repository includes navigational information, and ad content repository 125 includes one or more advertisements (or advertisement content). Repositories 121-125 may be maintained by the service provider of the advertisement-based navigational services, or by any other suitable third-party, such as one or more content providers 127. It is contemplated that the physical implementation of repositories 121-125 may take on many forms, including, for example, portions of existing repositories of a service provider, new repositories of a service provider, third-party repositories, and/or shared-repositories. As such, repositories 121-125 may be configured for communication over system 100 through any suitable messaging protocol, such as lightweight directory access protocol (LDAP), extensible markup language (XML), open database connectivity (ODBC), structured query language (SQL), and the like, as well as combinations thereof. In those instances when repositories 121-125 are provided in distributed fashions, information and content available via repositories 121-125 may be located utilizing any suitable querying technique, such as electronic number matching, distributed universal number discovery (DUNDi), uniform resource identifiers (URI), etc.

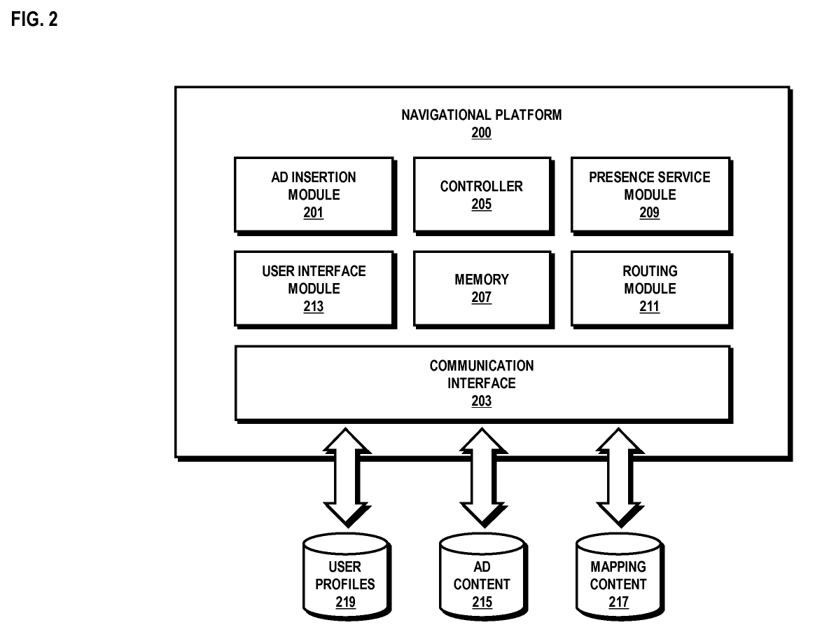

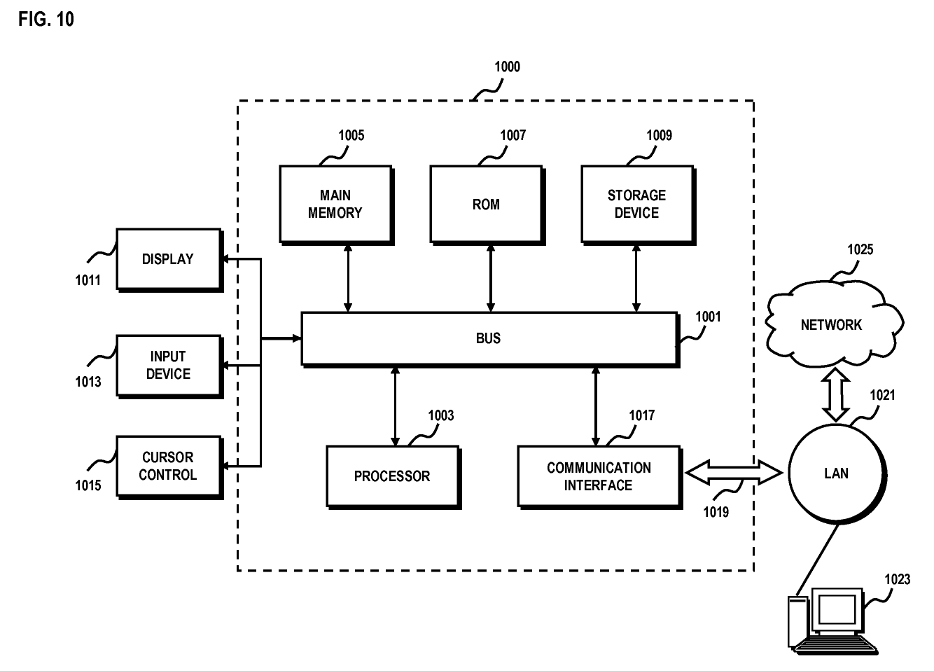

FIG. 2 is a diagram of a navigational platform configured to provide subscribers with routing directions and advertisements, according to an exemplary embodiment. Navigational platform 200 may comprise computing hardware (such as described with respect to FIG. 10), as well as include one or more components configured to execute the processes described herein for providing the advertisement-based navigational services of system 100. In one implementation, platform 200 includes ad insertion module 201, communication interface 203, controller (or processor) 205, memory 207, presence service module 209, routing module 211, and user interface module 213. Platform 200 may also communicate with one or more repositories, such as ad content repository 215, mapping content repository 217, and user profiles repository 219. Further, users may access platform 200 via client devices 107-111. It is also contemplated that platform 200 may embody many forms and include multiple and/or alternative components. For example, it is contemplated that the components of platform 200 may be combined, located in separate structures, or separate locations. Namely, a specific topology is not critical to embodiments of platform 200 or system 100 for that matter.

According to one embodiment, platform 200 embodies one or more application servers accessible to user devices 107-111 over one or more of networks 113-119. Users (or subscribers) access platform 200 to register to and receive authentication information for the advertisement-based navigational services of system 100, as well as to create, customize, and manage one or more user-defined advertisement policies enabling subscribers to opt-in or opt-out of receiving navigational information along with advertisements in exchange for subscription subsidies to the advertisement-based navigational services. As mentioned, navigational and/or advertisement information (or content) may be dynamically provided to users based on real-time positioning information and, in certain instances, based on (or in correlation with) user profile information and/or the navigational information. As such, platform 200 provides a user interface, e.g., a voice portal, web portal, or an otherwise networked application, to permit user (or subscriber) access to the features and functionality of platform 200 via user devices 107-111. According to certain embodiments, user interface module 213 may be configured for exchanging information between user devices 107-111 and a web browser or other networked-based application or system, such as a voice browser or interactive voice recognition system. In exemplary embodiments, user interface module 213 executes a graphical user interface (GUI) application configured to provide users with one or more menus of options for creating, customizing, and managing user profiles and requesting navigational information (e.g., routing directions, etc.), as well as engaging with other features of the advertisement-based navigational services of system 100.

In this way, routing module 211 is configured to retrieve mapping content from, for example, mapping content repository 217 in order to generate one or more topological depictions (or maps) of various geographic areas, as well as plan one or more routes (or trips) from starting locations to ending (or destination) locations within the geographic areas. Determined routes may also include one or more intermediary locations. The starting, intermediary, and/or ending locations may correspond to one or more POIs related to advertisement content or one or more user-input addresses, landmarks, positions, etc., that are of relevance to the user. Routing directions, e.g., turn-by-turn directions, may also be generated by routing module 211, wherein determined routes, corresponding movements (e.g., merges, turns, etc.), and the like, can be overlaid on generated maps and provided to users at for, example, mobile device 109. Routing module 211 may utilize various link and node data corresponding to the geographic areas at least including the starting locations, end locations, and the one or more intermediary locations of a user. Additionally, routing module 211 may utilize “current” spatial positioning of users to determine distances from various destinations. Distance values may be contingent upon a route that a user selects for navigational purposes. Likewise, routing module 211 may also utilize the real-time positioning information, as well as end destinations to determine one or more ETAs for the end destinations. Routing module 211 may also be configured to dynamically provide ETA information for arriving at predetermined destinations corresponding to advertisement information. In this way, users can gain an appreciation for the extra amount of travel time that visiting an end destination or location associated with advertisement content will cause.

According to particular embodiments, routing module 211 may generate this content (or information) “on-the-fly” based on real-time positioning information corresponding to the spatial position (or location) of a user. The real-time positioning information may be obtained from a mobile device of a user, e.g., mobile device 109, and tracked via presence service module 209. Additionally, presence service module 209 may “poll” mobile devices 109 for positioning information, as well as capture presence information or availability of mobile devices 109, i.e., of subscribers to the managed navigational services of system 100. An exemplary model for presence determination is detailed in Internet Engineering Task Force (IETF) Request for Comment (RFC) 2778, which is incorporated herein by reference in its entirety. According to certain embodiments, the presence or availability of mobile devices (e.g., mobile station 109) may be utilized to initiate the managed navigational services of system 100.

In exemplary embodiments, the navigational information, presence information, real-time positioning information, and/or user profile information corresponding to the respective subscribers of the advertisement-based navigational services may be utilized by ad insertion module 201 to request advertisements (or advertisement content) from, for example, advertisement platform 103, ad content repository 215, and/or one or more third-party content providers, such as content providers 127. As such, ad insertion module 201 may generate requests for advertisements based on navigational information (e.g., predetermined routing directions), spatial positioning (or location) of subscribers, and/or user profile information, such as one or more parameters, criteria, information etc., of a user-defined advertisement policy. It is further noted that generated requests for advertisements may include one or more of these types of information. In this manner, ad insertion module 201 may also be configured to embed, correlate, combine, and/or sequence received advertisements (or advertisement content) with navigational information. This may be performed before or during transmission of the navigational and/or advertisement information to subscribers via communication interface 203.

In order to provide selective access to the features and functionality of the advertisement-based navigational services of system 100, navigational platform 200 may also include an authentication module (not illustrated) for authenticating (or authorizing) users to the services. It is contemplated that the authentication module may operate in concert with communication interface 203 and/or user interface module 213. That is, the authentication module may verify user provided credential information acquired via communication interface 203 or user interface module 213 against corresponding credential information stored within a user profile of user profiles repository 219. By way of example, the credential information may include “log on” information corresponding to a user name, password, coded key, or other unique identification parameter, such a personal identification number (PIN). In other embodiments, the credential information may include any one, or combination of, a birth date, an account number (e.g., bank, credit card, billing code, etc.), a social security number (SSN), an address (e.g., work, home, IP, media access control (MAC), etc.), or telephone listing (e.g., work, home, cellular, etc.), as well as any other form of uniquely identifiable datum, e.g., biometric code, voice print, etc. Users may provide this information via user devices 107-111, such as by spoken utterances, dual-tone multi-frequency signals (DTMF), packetized transmission, etc. Unobtrusive security may be provided by positively identifying and screening users based on one or more of the aforementioned credentials which may be seamlessly provided when user devices 107-111 communicate with platform 200, such as a unique IP or MAC address. Other unobtrusive measures can be made available via user specific voice prints, etc.

Additionally, platform 200 may include one or more controllers (or processors) 205 for effectuating the aforementioned managed navigational services, as well as one or more memories 207 for permanent or temporary storage of one or more of the aforementioned variables, parameters, criteria, or information.

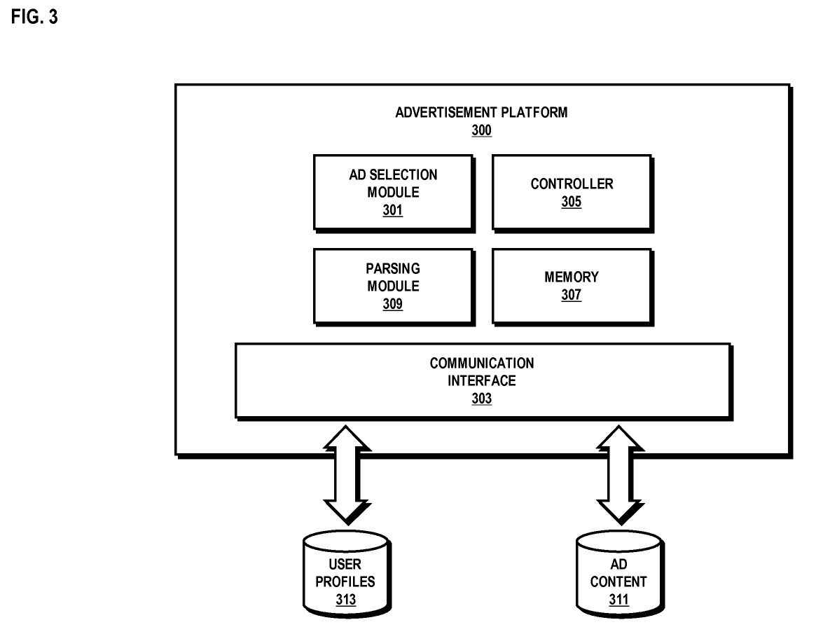

FIG. 3 is a diagram of an advertisement platform configured to select advertisements, according to an exemplary embodiment. Advertisement platform 300 may comprise computing hardware (such as described with respect to FIG. 10), as well as include one or more components configured to execute the processes described herein for providing the advertisement-based navigational services of system 100. In one implementation, platform 300 includes ad selection module 301, communication interface 303, controller (or processor) 305, memory 307, and parsing module 309. Platform 300 may also communicate with one or more repositories, such as ad content repository 311 and user profiles repository 313. It is also contemplated that platform 300 may embody many forms and include multiple and/or alternative components. For example, it is contemplated that the components of platform 300 may be combined, located in separate structures, or separate locations. In this manner, it is particularly noted that platforms 200 and 300 may be combined, located in separate structures, and/or separate locations.

According to exemplary embodiments, ad selection module 301 is configured to receive, via communication interface 303, requests for advertisements (or advertisement content) from, for example, navigational platform 101 or user devices 107-111. As previously mentioned, requests for advertisement content may include navigational information, spatial positioning (or location) of subscribers, and/or user profile information. As such, ad selection module 301 may port the advertisement request to parsing module 309 for determining a type of advertisement to select and/or retrieve. For example, a request for advertisements may be a request for location-based advertisements. As such, parsing module 309 may extract (or otherwise obtain) “current” positioning information and/or navigational information (e.g., routing directions) corresponding to a particular mobile device 109 from a request for advertisement content associated with mobile device 109, or may retrieve such information from navigational platform 101, user profiles repository 313, user device 109, or any other suitable source.

Additionally (or alternatively), advertisement content may be selected and retrieved based on information stored to respective user profiles of subscribers, such as one or more parameters or criteria of user-defined advertisement policies. As such, parsing module 309 may extract (or otherwise obtain) user profile information corresponding to a particular user device 107-111 from a request for advertisement content associated with user devices 107-111, or may retrieve such information from navigational platform 101, user profiles repository 313, user devices 107-111, or any other suitable source.

To this end, parsing module 309 may port positioning (or location) information, navigational information, and/or user profile information to ad selection module 301 for selecting and retrieving, based on this information, one or more advertisements (or advertisement content) from, for example, ad content repository 311 or one or more third-party content providers, such as content providers 127. In other instances, ad selection module 301 may signal ad content repository 311 or one or more of the third-party content providers, such as content providers 127, to provide navigational platform 101 or one or more of user-devices 107-111 with selected advertisement information. As such, ad selection module 301 may select advertisements that are specifically targeted to one or more subscribers.

Additionally, platform 300 may include one or more controllers (or processors) 305 for effectuating the aforementioned advertisement-based navigational services, as well as one or more memories 307 for permanent or temporary storage of one or more of the aforementioned variables, parameters, criteria, or information.

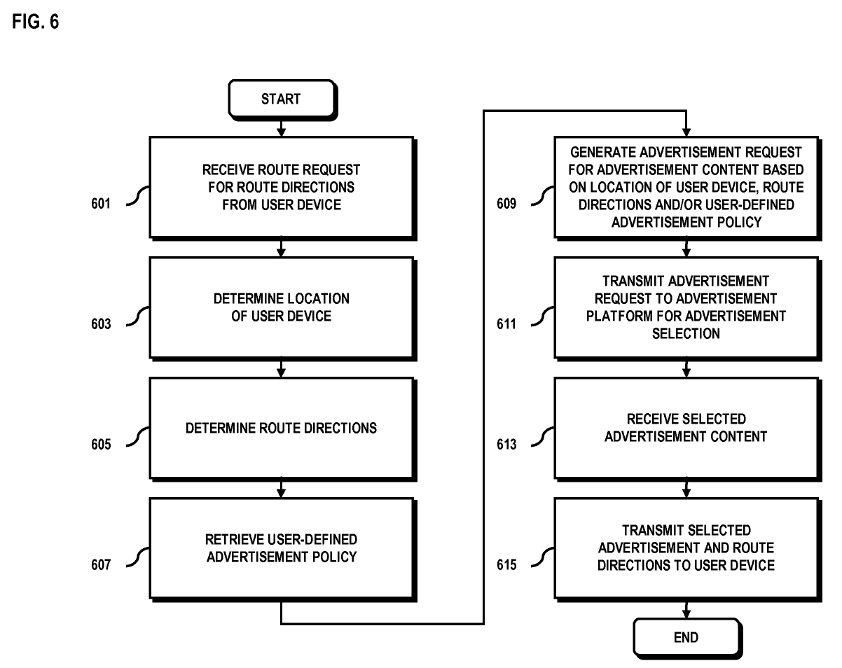

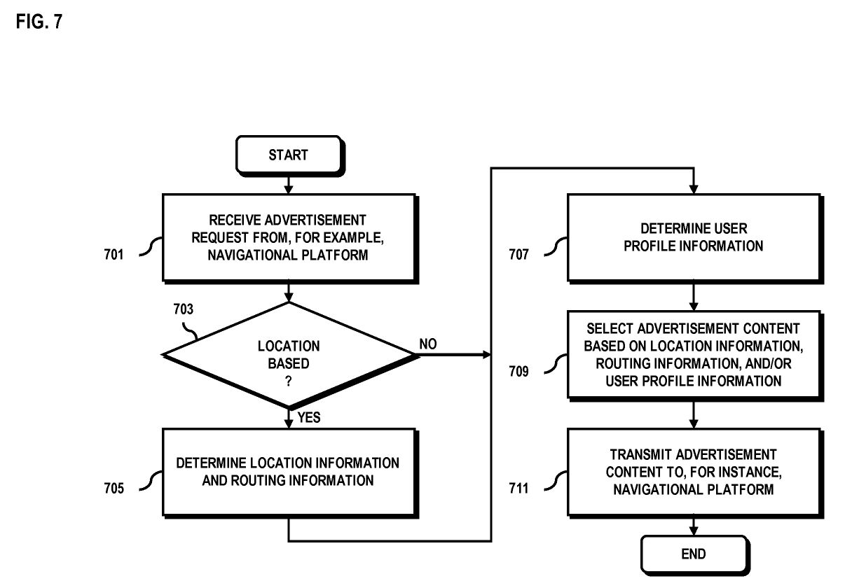

Exemplary processes for providing navigational and/or advertisement information are described with respect to FIGS. 6 and 7. Exemplary presentations of such information are more fully explained in accordance with FIGS. 9A and 9B.

FIG. 4 is a diagram of a mobile device, according to an exemplary embodiment. Mobile device 400 may comprise computing hardware (such as described with respect to FIG. 10), as well as include one or more components configured to execute the processes described herein for accessing the advertisement-based navigational services of system 100. It is noted that certain features, functions, and/or interactions of mobile device 400 are explained in conjunction with or reference to FIGS. 1-3. In this example, mobile device 400 includes ad (or advertisement) insertion module 401, ad selection module 403, audio interface 405, controller (or processor) 407, display 409, keyboard 411, location module 413, memory 415, radio circuitry 417 coupled to antenna 419, routing module 421, and wireless controller 423. While specific reference will be made hereto, it is also contemplated that mobile device 400 may embody many forms and include multiple and/or alternative components.

According to various exemplary embodiments, mobile device 400 is configured to dynamically receive, control, and present navigational and/or advertisement information to subscribers. As such, mobile device 400 may include one or more client programs (not shown) that operate thereon for providing the advertisement-based navigational services of system 100; however, it also is contemplated that these (or other) client programs may be executed via navigational platform 101 and, thereby, made accessible to users via mobile device 400. In one embodiment, these client programs may relate to one or more graphical user interfaces (GUI) configured to control the presentation of navigational and/or advertisement information, such as real-time routing directions embedded with, for instance, periodic advertisement content. To this end, the GUIs may be configured to facilitate the acquisitioning, exchanging, managing, sharing, storing, and/or updating of navigational information and/or advertisement information via mobile device 400.

In various instances, network browser applications may be provided for accessing similar applications made available by, for example, navigational platform 101. Users may interface with these client programs via audio interface 405, display 409, keyboard 411, and/or any other suitable input mechanism, e.g., buttons, joysticks, soft controls, touch panels, widget applications, etc. As such, audio interface 405 may include one or more components and corresponding functionality for effectuating a voice interface, e.g., speech synthesis and voice recognition capabilities.

Accordingly, the one or more client programs may be stored to memory 415, which may include volatile and/or non-volatile memory, such as erasable programmable read-only memory (EPROM), electrically erasable programmable read-only memory (EEPROM), flash memory, random access memory (RAM), read only memory (ROM), etc. Memory 415 may be implemented as one or more discrete devices, stacked devices, or integrated with controller (or processor) 407. In addition, communication signals, such as navigational and/or advertisement information, received by mobile device 400 may also be stored to memory 415. Exemplary GUIs capable of execution on mobile device 400 are described in association with FIGS. 9A and 9B.

Real time positioning information may be obtained or determined via location module 413 using SPS technology, such as GPS technology. In this way, location module 413 can behave as (or substantially similar to) a GPS receiver. Thus, mobile device 400 employs location module 413 to communicate with a constellation 129 of satellites. These satellites 129 transmit very low power interference and jamming resistant signals received by GPS receivers 413. At any point on Earth, GPS receiver 413 can receive signals from multiple satellites, such as six to eleven. Specifically, GPS receiver 413 may determine three-dimensional geolocation (or spatial positioning information) from signals obtained from at least four satellites. Measurements from strategically positioned satellite tracking and monitoring stations are incorporated into orbital models for each satellite to compute precise orbital or clock data. Accordingly, GPS signals may be transmitted over two spread spectrum microwave carrier signals that can be shared by GPS satellites 129. Thus, if mobile device 400 is able to identify signals from at least four satellites 129, receivers 413 may decode the ephemeris and clock data, determine the pseudo range for each satellite 129 and, thereby, compute the spatial positioning of a receiving antenna (not shown). With GPS technology, mobile device 400 can determine its spatial position with great accuracy and convenience.

Additionally, mobile device 400 may employ A-GPS to mitigate the loss of GPS signals from obstructions between GPS receiver 413 and satellites 129. When operating in A-GPS mode, mobile device 400 can provide for better in building or obstructed view spatial positioning. Assistance data can be transmitted to mobile device 400 from, for example, wireless network 117. In an exemplary embodiment, A-GPS information may include ephemeris data, differential GPS correction data, timing data, and/or other suitable aiding data. Using the aiding (or assistance) data, location module 413 performs spatial positioning calculations via, for example, controller (or processor) 407 that, in exemplary embodiments, may be utilized by mobile device 400 to generate real-time speed and/or route adherence alerts. Additionally, transmission of the spatial positioning information need not be frequent. Transmission of the geolocation data can be made more compact because it may relate to “true” location rather than pseudo range data. Also, mobile device 400 may intelligently request assistance data when the device itself determines that ephemeris data is no longer valid. It is also contemplated that other suitable navigation and location determination technologies may be utilized, such as A-FLT, CELL-ID, WLAN, etc. In any case, however, determined spatial positioning information may be transmitted to platforms 101 and/or 103 via radio circuitry 417 and/or wireless controller 423. It is generally noted that wireless controller 423 may also be used to communicate with a wireless headset (not shown). The headset may employ any number of standard radio technologies to communicate with wireless controller 423; for example, the headset may be BLULETOOTH enabled. It is also contemplated that other equivalent short range radio technology and protocols may be utilized.

Received navigational information, such as one or more geographic maps, POIs, routing (or location-to-location) directions, ETAs, landmarks, traffic reports, road conditions, weather notifications, etc., and/or advertisement content (e.g., advertisement 105) may be presented to users via audio interface 405 and/or display 409. Mobile device 400 is also configured to store and execute instructions for supporting the advertisement-based navigational services of system 100, as well as other communication functions made available via radio circuitry 417. In this manner, controller 407 controls the operation of mobile device 400 according to programs and/or data stored to memory 415. Control functions may be implemented in a single controller (or processor) or via multiple controllers (or processors), such as one or more general purpose and/or special purpose controllers, as well as digital signal processors, local oscillators, microprocessors, and the like. Controller 407 may also be implemented as a field programmable gate array controller, reduced instruction set computer processor, etc. Controller 407 may interface with audio interface 405 to provide analog output signals to one or more speakers (not shown) and receive analog audio input from one or more microphones (not illustrated) of audio interface 405.

According to some embodiments, mobile device 400 includes ad selection module 403, ad insertion module 401 and routing module 421 for assuming one or more of the aforementioned features and functions described with respect to navigational platform 200 and/or advertisement platform 300. In this way, modules 401, 403 and 421 operate similarly to modules 201 and 211 of navigational platform 200 and module 301 of advertisement platform 300. It is noted, however, that real-time positioning information can be acquired via location module 413, instead of (or in addition to) presence service module 209. Likewise, the parsing functions of parsing module 309 may be assumed by controller 407.

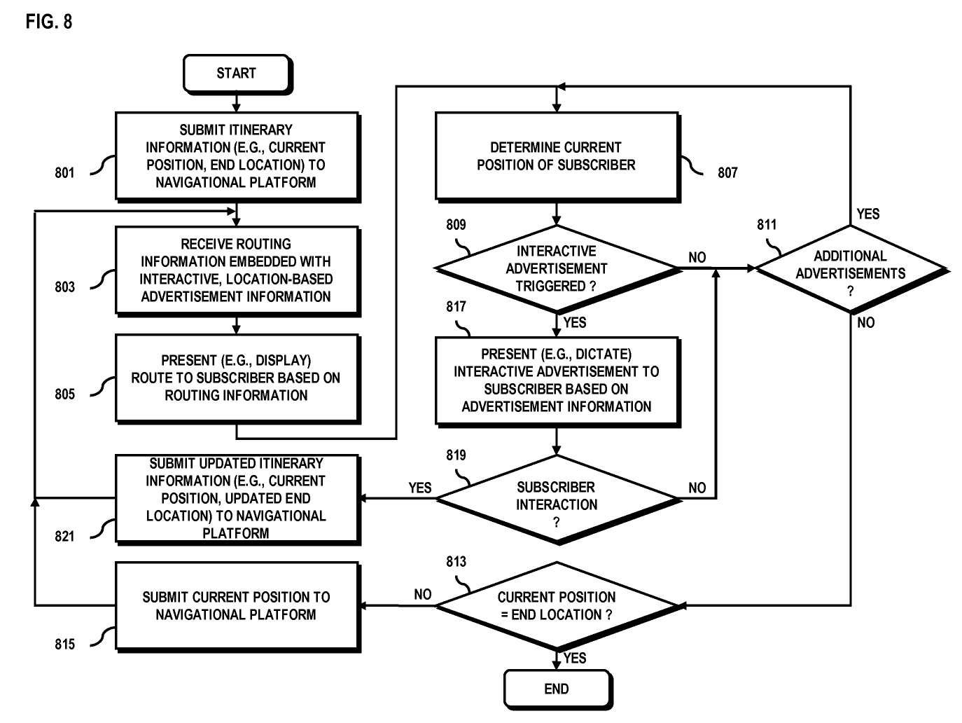

An exemplary process for presenting navigational and/or advertisement information to users of mobile device 400 is described with respect to FIG. 8. As mentioned, exemplary presentations of such information are more fully explained in accordance with FIGS. 9A and 9B.

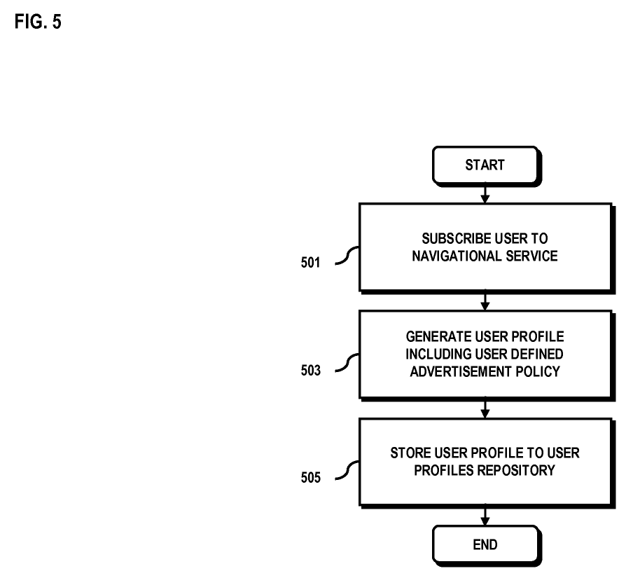

FIG. 5 is a flowchart of a process for generating user profiles including user-defined advertisement policies, according to an exemplary embodiment. For illustrative purposes, the process is described with reference to FIGS. 1, 2, and 4. It is noted that the steps of the process may be performed in any suitable order, as well as combined or separated in any suitable manner. At step 501, navigational platform 200 subscribes a user to the advertisement-based navigational services of system 100. According to one embodiment, the user may subscribe utilizing a user device capable of processing and transmitting information over one or more of networks 113-119, such as computing device 107, mobile device 109, or voice station 111. Namely, the user may interact with an input interface (e.g., keyboard 411) of, for example, mobile device 109 to activate software resident on the device, such as a GUI or other networked application that interfaces with (or is implemented by) platform 200. Alternatively, the user may interact with a voice portal interfacing with (or implemented by) platform 200, wherein speech synthesis and voice recognition techniques are utilized to prompt the user for various inputs and to reduce the spoken utterances of the user to one or more corresponding inputs. As such, the user registers as a new subscriber of the managed navigational service, as well as obtains sufficient authentication information for establishing future sessions with platform 200 and/or platform 300. In certain embodiments, registration procedures may prompt the user to identify all user devices (e.g., user devices 107-111) that the user may employ to interact with system 100. In this manner, registered devices may be logically associated with the user.

Once registered, navigational platform 200 enables the user, per step 503, to generate a user profile including at least one user-defined advertisement policy for extending the advertisement-based navigational services to the user. The user profile may include the earlier described user profile information, e.g., username, password, account information, billing information, configuration information, and the like, as well as particular advertisement policy parameters enabling subscribers to opt-in or opt-out of receiving navigational information (e.g., routing directions, itineraries, points of interest (POI), estimated times of arrival (ETA), traffic information, weather information, etc.) embedded with (or otherwise supplemented by) advertisement content. According to various exemplary embodiments, additional parameters (or criteria) may be specified to govern the who, what, when, where, and how advertisements are to be received, such as the various aforementioned parameters defining amount, frequency, location, mode, subjects, timing, whitelists, blacklists, etc., for receiving advertisements in exchange for subscription subsidies. As such, the user may define a user profile that may be utilized to dynamically select, retrieve, and transmit targeted advertisements to subscribers while, for example, the user is en route to a predetermined destination. Thus, the user profile may specify one or more triggering events for dynamically providing subscribers with advertisement, such as advertisement 105.

After generating a user profile, navigational platform 200 stores the user profile to a list of subscribers to the advertisement-based navigational services of system 100, as well as a list of subscriber device identifiers, authentication information, and user-defined profile(s)/policies to user profiles repository 121, per step 505. It is noted that platform 200 may additionally (or alternatively) store or synchronize this information to a storage location or memory of, for instance, platform 200, platform 300, one or more memories of user devices 107-111, and/or any other suitable storage location or memory accessible to system 100. Further, it is contemplated that users may directly interact with one or more of these storage facilities, such as user profiles repository 121.

FIG. 6 is a flowchart of a process for providing subscribers with routing directions embedded with one or more advertisements, according to an exemplary embodiment. For illustrative purposes, the process is described with reference to FIGS. 1-4. It is noted that the steps of the process may be performed in any suitable order, as well as combined or separated in any suitable manner. At step 601, navigational platform 200 (i.e., routing module 211) receives from, for example, mobile device 109 a route request for routing directions over one or more of networks 113-119. In exemplary embodiments, the route request may include various navigational information corresponding to a mobile device associated the user (e.g., mobile device 400), such as a starting location, destination location, current location, and the like, as well as one or more other parameters specifying certain itinerary and/or waypoint information (e.g., intermediary destinations, road selection requests (e.g., minimize/maximize highways, minimize/maximize scenic routes, etc.), scheduling parameters, and the like. It is noted that, according to particular embodiments, the route request may also specify one or more of the aforementioned advertisement policy parameters. It is further noted that the start location may correspond to the current location of mobile device 400.

In step 603, presence service module 209 determines the location of mobile device 400, which may be based on information received in the route request, e.g., current location information. According to those instances when mobile device 400 provides platform 200 with its current position, presence service module 209 may parse the route request for this information or may track (or otherwise receive) the location of mobile device 400 in any other suitable manner. The location information may be ported to routing module 211, per step 605, for determination of one or more routing directions from one or more starting locations (e.g., current position of mobile device 400) to one or more destination locations specified in the received route request. It is noted that routing module 211 may further determine the routing directions based on one or more of the “other” parameters specified in the route request.

In this manner, the routing request may signal to routing module 211 that one or more advertisements are to included with (or otherwise embedded within) the routing directions and, thus, routing module 211 may request one or more advertisements (e.g., advertisement 105) from ad insertion module 201 to include as part of (or an addition to) the routing directions. At step 607, ad insertion module 201 retrieves (or receives), via communication interface 203, one or more user-defined advertisement policies associated with the user from, for instance, user profiles repository 121. It is also noted that ad insertion module 201 may retrieve the one or more user-defined advertisement policies based upon initialization of the advertisement-based navigational services of system 100 by the user. Service initialization may automatically occur in response to the user activating (e.g., powering on) mobile device 400 or selectively occur based on user interaction with a GUI interface of mobile device 400 or selection of a voice portal option. In alternative embodiments, retrieval of user-defined advertisement policies may be performed in response to reception of a route request. For instance, upon initial reception of the route request from mobile device 400, platform 200 may retrieve the user-defined advertisement policies and temporarily store it to a local memory (e.g., memory 207), such that when one or more parameters of the policies are required, the parameters need only be (but are not required to be) retrieved from memory 207.

Utilizing one or more of the parameters stored to the advertisement policies (and, in certain embodiments, one or more of the parameters included in the route request), ad insertion module 201 generates, per step 609, an advertisement request for advertisement content based on one or more variables, such as the location of mobile device 400, routing directions determined by routing module 211, and/or one or more of the aforementioned policy parameters, as well as any other suitable criterion, such as predetermined criteria specified by an administrator of the advertisement-based navigational services of system 100. At step 611, the request is transmitted (via communication interface 203) to advertisement platform 300 for advertisement (and/or advertisement content) selection. It is noted, however, that in those instances when navigational platform 101 includes the features or components of advertisement platform 103, the request may simply be ported to, for example, ad selection module 301. Additionally (or alternatively), the advertisement request may be provided (e.g., transmitted, ported, etc.) to ad content repository 125 and/or one or more third-party content providers 127 for providing selected advertisements to platform 101. An exemplary process for selecting advertisements is described in more detail in conjunction with FIG. 7.

Nevertheless, in step 613, navigational platform 101 (i.e., ad insertion module 201) receives selected advertisement content from, for example, advertisement platform 103, ad content repository 125, and/or one or more third party content providers 127. Once one or more selected advertisements (and/or advertisement content) are received, ad insertion module 201 transmits (via, for example, communication interface 203) the selected advertisements, e.g., advertisement 105, and the routing directions to mobile device 400 for presentation to the user of the device. It is contemplated that the advertisements may be embedded into the routing directions, provided as addendums thereto, or even separately transmitted to mobile device 400 for presentation.

FIG. 7 is a flowchart of a process for selecting advertisements, according to an exemplary embodiment. For illustrative purposes, the process is described with reference to FIGS. 1 and 3. It is noted that the steps of the process may be performed in any suitable order, as well as combined or separated in any suitable manner. At step 701, advertisement platform 300 (i.e., ad selection module 301) receives, via communication interface 303, a request for one or more advertisements (or advertisement content) from, for example, navigational platform 200. In certain exemplary embodiments, it is noted that mobile devices 109 may directly request advertisements (or advertisement content) from advertisement platform 300, such as in those instance when mobile devices 109 assume one or more of the functions and/or features of navigational platform 101. In any case, however, ad selection module 301 may port the advertisement request to parsing module 309 for determining, in step 703, whether the request is for location-based advertisements. That is, parsing module 309 may extract (or otherwise obtain) information from the advertisement request to determine if the advertisement request calls for advertisements correlated to a “current position” of mobile device 109. If the request includes one or more parameters indicating to parsing module 309 that the advertisement request seeks location-based advertisements, parsing module 309 may determine, in step 705, location information and routing information associated with the mobile device 109 corresponding to the request. It is noted that the location and/or routing information may be provided in the advertisement request and, therefore, parsing module 309 may extract this information from the request or may retrieve the information from one or more other components or facilities of system 100. For instance, parsing module 309 may acquire a “current” position of mobile device 109 from platform 101, mobile device 109, or any other suitable source, such as user profiles repository 121, user devices 109 and 111, etc. Likewise, the routing information may be, alternatively or additional, retrieved from platform 101 and/or one or more of user devices 107-111. If location-based advertisements are not requested, the process proceeds to step 707, wherein parsing module 309 determines user profile information (e.g., one or more user-defined advertisement policy parameters) corresponding to the user associated with the advertisement request. Again, this user profile information may be parsed (or otherwise extracted) from the advertisement request. It is noted that the location information, routing information, and/or user profile information may be ported to ad selection module 301 for selecting, based on this information, one or more advertisements (or advertisement content) for targeting to the user associated with the advertisement request, such as advertisement 105. In this manner, select advertisements (or advertisement content) may be transmitted to, for instance, navigational platform 101 via, for example, communication interface 303. It is also noted that the selected advertisements may be, additionally or alternatively, provided directly to user devices 107-111 (e.g., mobile device 109), such as in those instances when mobile device 109 assumes one or more of the responsibilities of navigational platform 101.

FIG. 8 is a flowchart of a process for presenting routing directions and advertisements to subscribers, according to an exemplary embodiment. For illustrative purposes, the process is described with reference to FIGS. 1, 2, and 4. It is noted that the steps of the process may be performed in any suitable order, as well as combined or separated in any suitable manner. At step 801, mobile device 400 establishes a communication session with, for example, navigational platform 101 via one or more of networks 113-119, wherein mobile device 400 submits various itinerary information (e.g., start location, destination location, current position, date of travel, time of travel, user-defined advertisement policy information, etc.) corresponding to a geographic area to navigational platform 101. That is, a user (e.g., subscriber of the advertisement-based navigational services of system 100) submits a route request for routing (e.g., turn-by-turn, location-to-location) directions to platform 101 via a GUI application provided by, for example, mobile device 400, navigational platform 101, the aforementioned portal, or any other suitable source. For the purposes of explanation, it is assumed that the route request is for location-to-location navigational purposes, wherein mobile device 400 is to dynamically receive navigational information, at least including the routing information, from navigational platform 101 while en route to one or more specified destination locations. In response, mobile device 400 receives, in step 803, various routing information (e.g., routing directions) embedded with interactive, location-based advertisement information (such as advertisement 105) from, for instance, navigational platform 101 over one or more of networks 113-119. According to certain exemplary embodiments, the routing information may relate to all or some portion of an intended itinerary. That is, navigational platform 101 may provide mobile device 400 with routing information embedded with interactive, location-based advertisement information “on-the-fly” and, thereby, transmitted to mobile device 400 as one or more streams of routing and/or advertisement information. In this manner, per step 805, mobile device 400 may receive routing and/or advertisement information, format it (as necessary), and presents (e.g., displays) all or some of a predetermined route to the subscriber based on the received routing information via, for example, controller 407, display 409 and/or memory 415. An exemplary presentation is further described in accordance with FIG. 9A.

Since it was assumed that the received advertisement content is “location-based,” controller 407, in conjunction with location module 413, determines, in step 807, a current position of the subscriber, i.e., a current position of mobile station 400. In this manner, controller 407 may determine whether to trigger the presentation (e.g., playback) of one or interactive advertisements, per step 809. If no interactive advertisements to be presented to the user based on the location of mobile station 400, controller 407 determines whether there exists any (or any additional) interactive advertisements available for presentation before additional routing information is required to be received, at step 811. If at least one interactive advertisement exists, the process reverts back to step 807. If no interactive advertisements are to be triggered, the process proceeds to step 813, wherein controller 407, in conjunction with location module 413, determines whether the “current” position of mobile device 400 corresponds to one or more destination locations. If the “current” position corresponds to a destination location, the process ends, otherwise mobile device 400 submits, as in step 815, the current position of subscriber to navigational platform 101 to obtain either updated advertisement information or a “next” series of routing information associated with an “on-the-fly” version of the predetermined route. In this manner, the process reverts to one or more of steps 803-811 until either the subscriber reaches a final destination or, in step 809, an interactive, location-based advertisement, e.g., advertisement 105, is triggered for presentation to the user.

Accordingly, at step 817, mobile station 400 presents (e.g., dictates, prompts, displays, etc.) the triggered interactive, location-based advertisement to the subscriber based on the advertisement information (or content) received from navigational platform 101. For instance, a triggered interactive, location-based advertisement may cause mobile station 400, via audio interface 405, to prompt the user with the following, “ABC Burger Restaurant, voted America's best burger establishment for the past 20 years, is within two miles of your current location. Wow, you're only 5 minutes away from the best burger you've ever had! Say ‘YES’ or press ‘ONE’ to reroute to ABC Burger Restaurant.” It is noted that presence service module 209 and routing module 211 of navigational platform 200 (or location module 413 and routing module 421 of mobile device 400) may dynamically provide ad insertion module 201 (or ad insertion module 401) with the distance from current location information and/or estimated time away from the advertised location so that such information may be dynamically presented to the subscriber. In step 819, controller 407 determines whether or not the subscriber has submitted a response or otherwise interacted with the interactive, location-based advertisement. That is, controller 407 monitors for associated auditory input to audio interface 405, associated input to, for example, keyboard 411, or associated input to any other suitable input interface of mobile device 400, such as input to a touch screen (not shown) of mobile device 400. If controller 407 does not detect subscriber interaction with the interactive, location-based advertisement, the process reverts to step 811. If controller 407 detects suitable subscriber interaction, mobile station 400 submits, as in step 821, updated itinerary information (e.g., current position, updated destination location, etc.) to, for example, navigational platform 200. In this manner, the process reverts to one or more of steps 803-821 until the current position of mobile device 400 corresponds to an end (or destination) location.

FIG. 9A is a diagram of a mobile device for presenting routing directions and advertisements, according to an exemplary embodiment. In this example, users may employ mobile device 900 to submit, for example, route requests to navigational platform 101 and obtain navigational information (e.g., routing directions) and/or advertisement information (or content) from one or more of navigational platform 101 and advertisement platform 103. It is noted that the navigational information and the advertisement information may be dynamically provided to mobile device 900 from, for instance, navigational platform 101 based on real-time positional information corresponding to the location of mobile device 900. For illustrative purposes, mobile device 900 is described with respect to a mobile phone, such as a cellular phone, configured to provide a GUI 901 to users via display 903. While shown presenting navigational information (e.g., mapping content, routing directions, POI information, estimated time of arrival information, etc.), GUI 901 enables users to submit route requests and obtain navigational information and/or advertisement, as well as interact with interactive advertisements, such as advertisement 105. Auditory components of the various forms of information (or content), such as turn-by-turn directions, approaching POI announcements, descriptions, advertisements, or other mapping information, may be output via one or more suitable transducers (e.g., speakers) 905. Cursor buttons 907, keypad 909, and microphone 911 enable users to interact with GUI 901 of display 903. As such, mobile device 900 is, in exemplary embodiments, also capable of speech synthesis and voice recognition.

According to one embodiment, GUI 901 presents an identified POI 913 corresponding to an audio advertisement that is assumed to be conveyed to a user of mobile device 900 via transducers 905. In certain instances, POI 913 may be overlaid on, for example, a topological depiction (or map) 915 of a geographic area surrounding POI 913. Additionally, POI 913, map 915 may include various cartographic features, such as one or more buildings, designators, landmarks, roadways, signs, etc. Further, map 915 may be utilized for navigation and, therefore, may include a current spatial position 917 of the user, as well as a route 919 that is “currently” being traversed by the user of mobile device 900. GUI 901 may also provide users with distance information 921 and timing information 923 corresponding to a predetermined end destination (not illustrated) and, thereby, relating to the proximity of the end destination to the current spatial position 917 of the user and route 919. As shown, distance information 921 conveys an amount of “additional travel distance” required for visiting the end destination, and timing information 923 conveys an amount of “additional travel time” required for visiting the end destination.

In exemplary embodiments, GUI 901 may provide one or more sections for conveying turn-by-turn directions, e.g., sections 925, 927, and 929. Section 925 provides a depiction of a “next” direction of travel, e.g., right turn, whereas section 927 provides an amount of distance in which the “next” direction of travel will be encountered, e.g., “0.7 MILES.” Further, section 929 provides a description of the “next” direction, e.g., “RIGHT TURN AT F ST.” Other information concerning the end destination may be presented in sections 931 and 933. As shown, section 931 provides a title (or name) of the end destination, i.e., “VERIZON CENTER,” while section 933 provides an address of the end destination, i.e., “600 F ST, NW, WASHINGTON, DC 20004.” It is contemplated, however, that sections 921 and 923 may be utilized to convey other navigational information, such as metadata corresponding to the end destination, e.g., contact information, description, hours of operation, product or service offerings (e.g., menus, catalogues, etc.), product or service prices, etc. In other embodiments, textual and/or graphic advertisements may be provided in one or more of sections 931 and 933, or any other suitable region of GUI 901.

Accordingly, GUI 901 may include various GUI features for viewing this information via display 903, such as in a new or different window, as overlay content within the illustrated window, etc. These GUI features may include navigation trees, an expandable table of contents, or FlashMedia presentation of selectable entries. GUI 901 may also include various input fields, selectable elements (e.g., toggle buttons, check boxes, radio buttons, sliders, list boxes, spinners, drop-down lists, menus, toolbars, ribbons, combo boxes, icons, etc.), output fields (e.g., labels, tooltips, balloon helps status bars, progress bars, infobars, etc.) and windows, as well as any other suitable interface widget for interfacing with GUI 901 and/or the various features of the advertisement-based navigational services of system 100.

As an illustrative example, an audio, location-based, interactive advertisement may be emitted via transducers 905 and presented by mobile device 900 as POI 913. The audio portion may prompt the user with the following:
For the next two hours only, the National Air and Space Museum is providing the first 200 patrons with free, collector addition model airplanes. Wow, you're less than a half a mile away, that's less than 2 minutes from your choice between three totally free collector addition model airplanes! Say “YES” or press the star on your display screen to reroute to the National Air and Space Museum. Oh, and don't forget, this exclusive, one time only offer will expire in the next two hours, that is, if supplies last. So act fast!

Accordingly, reception of auditory content at microphone 911 or interaction with POI 913, e.g., selection of POI 913, enables users to obtain augmented and/or updated navigational information including, for instance, distance information, routing information, and timing information corresponding to POI 913 and, thereby, to the aforementioned location-based, interactive advertisement. An updated presentation is explained in more detail in conjunction with FIG. 9B. While not illustrated, GUI 901 may also include “soft controls” for controlling the presentation of GUI 901, inputting information, or otherwise enabling user interaction with GUI 901, e.g., interaction with POI 913 and/or the audio advertisement. These functions may also be provided via cursor buttons 907, keypad 909, and microphone 911. In addition, GUI 901 may be employed for the purposes of registering to the advertisement-based navigational services of system 100, as well as creating, customizing, and managing one or more user profiles including, for instance, at least one user-defined advertisement policy. It is also noted that GUI 901 may enable users to search one or more memories or repositories, such as user profiles repository 121, mapping content repository 123, and ad content repository 1XX. In other instances, GUI 901 may be utilized to submit routing requests to, for example, navigational platform 101 and, thereby, obtain navigational information. In such instances, GUI 901 may include one or more fields for inputting parameters and/or one or more soft controls corresponding to, for example, an alphanumeric keyboard or other suitable interface for inputting parameters. The controls, input fields, and presentations may also be provided via transducer(s) 905 and microphone 911 acting as an interactive voice response (IVR) interface.

FIG. 9B is a diagram of a mobile device display presenting updated routing directions in response to subscriber interaction with a location-based, interactive advertisement, according to an exemplary embodiment. In this example, display 950 may be provided by mobile device 900 of FIG. 9A. It is noted that presentation of this navigational information may be in response to user interaction with the illustrative advertisement of FIG. 9A. Display 950 includes, similarly to that of GUI 901, identified POI 913 overlaid on topological depiction (or map) 915 of the geographic area surrounding POI 913. It is noted, however, that POI 913 now corresponds to a “current” end destination. It is also generally noted that the presentation of display 950 will include sufficient detail so as to provide meaningful feedback to the user with respect to a current location and/or planned route of the user. That is, map 915 may be utilized for navigation and, therefore, may include a current spatial position 951 of the user, as well as a planned route 953 that is “currently” being traversed by the user of, for example, mobile device 900. In this example, however, display 950 provides an augmented (or updated) presentation corresponding to user interaction with the illustrative advertisement of FIG. 9A. Namely, route 919 has been amended to route 953 including updated route section 955 selectively accounting for approaching end destination 913. As such, display 950 includes updated distance information 957 and updated timing information 959 corresponding to the user approaching end destination 913 via route 953. While not illustrated, distance, timing, and routing information for previously identified and planned destinations may also be updated based on the possibility that the user may visit or the user actually selecting to visit POI 913. Furthermore, sections 925-929 of FIG. 9A may be amended to sections 961, 963, and 965 to convey updated turn-by-turn (or routing) directions. As before, section 961 provides a depiction of a “next” direction of travel, e.g., right turn, while section 963 provides an amount of distance in which the “next” direction of travel will be encountered, e.g., “213 FEET.” Further, section 965 provides a description of the “next” direction, e.g., “RIGHT TURN AT INDEPENDENCE AVE.”

Similar to sections 931 and 933, other information concerning end destination 913 may be presented in sections 967 and 969. As shown, section 967 provides a title (or name) of approaching end destination 913, i.e., “NATIONAL AIR AND SPACE MUSEUM,” while section 969 provides an address of end destination 913, i.e., “600 INDEPENDENCE AVE, SW, WASHINGTON, DC 20024.” It is contemplated, however, that sections 967 and 969, like sections 931 and 933, may be utilized to convey other navigational information, such as metadata corresponding to end destination 913, e.g., contact information, description, hours of operation, product or service offerings (e.g., menus, catalogues, etc.), product or service prices, etc. As before, sections 967 and 969 (or any other suitable region display 950) may provide for textual and/or graphic advertisements triggered while mobile device 900 is traversing route 953. In this manner, display 950, like GUI 901, may include various GUI features for viewing this information, such as in a new or different window, as overlay content within the illustrated window, etc. These GUI features may include navigation trees, an expandable table of contents, or FlashMedia presentation of selectable entries. Display 950 may also include various input fields, selectable elements (e.g., toggle buttons, check boxes, radio buttons, sliders, list boxes, spinners, drop-down lists, menus, toolbars, ribbons, combo boxes, icons, etc.), output fields (e.g., labels, tooltips, balloon helps status bars, progress bars, infobars, etc.) and windows, as well as any other suitable interface widget for interfacing display 950 and/or the various features of the advertisement-based navigational services of system 100.

The processes described herein for providing advertisement-based navigational services may be implemented via software, hardware (e.g., general processor, Digital Signal Processing (DSP) chip, an Application Specific Integrated Circuit (ASIC), Field Programmable Gate Arrays (FPGAs), etc.), firmware or a combination thereof. Such exemplary hardware for performing the described functions is detailed below.

FIG. 10 illustrates computing hardware (e.g., computer system) 1000 upon which an embodiment according to the invention can be implemented. The computer system 1000 includes a bus 1001 or other communication mechanism for communicating information and a processor 1003 coupled to the bus 1001 for processing information. The computer system 1000 also includes main memory 1005, such as a random access memory (RAM) or other dynamic storage device, coupled to the bus 1001 for storing information and instructions to be executed by the processor 1003. Main memory 1005 can also be used for storing temporary variables or other intermediate information during execution of instructions by the processor 1003. The computer system 1000 may further include a read only memory (ROM) 1007 or other static storage device coupled to the bus 1001 for storing static information and instructions for the processor 1003. A storage device 1009, such as a magnetic disk or optical disk, is coupled to the bus 1001 for persistently storing information and instructions.

The computer system 1000 may be coupled via the bus 1001 to a display 1011, such as a cathode ray tube (CRT), liquid crystal display, active matrix display, or plasma display, for displaying information to a computer user. An input device 1013, such as a keyboard including alphanumeric and other keys, is coupled to the bus 1001 for communicating information and command selections to the processor 1003. Another type of user input device is a cursor control 1015, such as a mouse, a trackball, or cursor direction keys, for communicating direction information and command selections to the processor 1003 and for controlling cursor movement on the display 1011.

According to an embodiment of the invention, the processes described herein are performed by the computer system 1000, in response to the processor 1003 executing an arrangement of instructions contained in main memory 1005. Such instructions can be read into main memory 1005 from another computer-readable medium, such as the storage device 1009. Execution of the arrangement of instructions contained in main memory 1005 causes the processor 1003 to perform the process steps described herein. One or more processors in a multi-processing arrangement may also be employed to execute the instructions contained in main memory 1005. In alternative embodiments, hard-wired circuitry may be used in place of or in combination with software instructions to implement the embodiment of the invention. Thus, embodiments of the invention are not limited to any specific combination of hardware circuitry and software.

The computer system 1000 also includes a communication interface 1017 coupled to bus 1001. The communication interface 1017 provides a two-way data communication coupling to a network link 1019 connected to a local network 1021. For example, the communication interface 1017 may be a digital subscriber line (DSL) card or modem, an integrated services digital network (ISDN) card, a cable modem, a telephone modem, or any other communication interface to provide a data communication connection to a corresponding type of communication line. As another example, communication interface 1017 may be a local area network (LAN) card (e.g. for Ethernet™ or an Asynchronous Transfer Model (ATM) network) to provide a data communication connection to a compatible LAN. Wireless links can also be implemented. In any such implementation, communication interface 1017 sends and receives electrical, electromagnetic, or optical signals that carry digital data streams representing various types of information. Further, the communication interface 1017 can include peripheral interface devices, such as a Universal Serial Bus (USB) interface, a PCMCIA (Personal Computer Memory Card International Association) interface, etc. Although a single communication interface 1017 is depicted in FIG. 10, multiple communication interfaces can also be employed.

The network link 1019 typically provides data communication through one or more networks to other data devices. For example, the network link 1019 may provide a connection through local network 1021 to a host computer 1023, which has connectivity to a network 1025 (e.g. a wide area network (WAN) or the global packet data communication network now commonly referred to as the “Internet”) or to data equipment operated by a service provider. The local network 1021 and the network 1025 both use electrical, electromagnetic, or optical signals to convey information and instructions. The signals through the various networks and the signals on the network link 1019 and through the communication interface 1017, which communicate digital data with the computer system 1000, are exemplary forms of carrier waves bearing the information and instructions.

The computer system 1000 can send messages and receive data, including program code, through the network(s), the network link 1019, and the communication interface 1017. In the Internet example, a server (not shown) might transmit requested code belonging to an application program for implementing an embodiment of the invention through the network 1025, the local network 1021 and the communication interface 1017. The processor 1003 may execute the transmitted code while being received and/or store the code in the storage device 1009, or other non-volatile storage for later execution. In this manner, the computer system 1000 may obtain application code in the form of a carrier wave.

The term “computer-readable medium” as used herein refers to any medium that participates in providing instructions to the processor 1003 for execution. Such a medium may take many forms, including but not limited to non-volatile media, volatile media, and transmission media. Non-volatile media include, for example, optical or magnetic disks, such as the storage device 1009. Volatile media include dynamic memory, such as main memory 1005. Transmission media include coaxial cables, copper wire and fiber optics, including the wires that comprise the bus 1001. Transmission media can also take the form of acoustic, optical, or electromagnetic waves, such as those generated during radio frequency (RF) and infrared (IR) data communications. Common forms of computer-readable media include, for example, a floppy disk, a flexible disk, hard disk, magnetic tape, any other magnetic medium, a CD-ROM, CDRW, DVD, any other optical medium, punch cards, paper tape, optical mark sheets, any other physical medium with patterns of holes or other optically recognizable indicia, a RAM, a PROM, and EPROM, a FLASH-EPROM, any other memory chip or cartridge, a carrier wave, or any other medium from which a computer can read.

Various forms of computer-readable media may be involved in providing instructions to a processor for execution. For example, the instructions for carrying out at least part of the embodiments of the invention may initially be borne on a magnetic disk of a remote computer. In such a scenario, the remote computer loads the instructions into main memory and sends the instructions over a telephone line using a modem. A modem of a local computer system receives the data on the telephone line and uses an infrared transmitter to convert the data to an infrared signal and transmit the infrared signal to a portable computing device, such as a personal digital assistant (PDA) or a laptop. An infrared detector on the portable computing device receives the information and instructions borne by the infrared signal and places the data on a bus. The bus conveys the data to main memory, from which a processor retrieves and executes the instructions. The instructions received by main memory can optionally be stored on storage device either before or after execution by processor.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A method comprising:
receiving a route request from a user device for route directions;
generating an advertisement request for advertisement content;
determining location of the user device and routing information associated with the route directions;
transmitting the advertisement request to an advertisement platform that selects an advertisement based on the location of the user device and the routing information;
receiving the selected advertisement; and
transmitting the selected advertisement along with the route directions to the user device.

2. A method according to claim 1, wherein the selected advertisement is an audio advertisement.

3. A method according to claim 2, wherein the advertisement is selected based on user profile information.

4. A method according to claim 2, wherein the audio advertisement is presented during execution of route directions based on the location of the device.

5. A method according to claim 1, wherein the user device is a mobile phone.

6. A method according to claim 1, wherein the selected advertisement is provided to the user device as part of a global positioning system based navigational service.

7. A method according to claim 1, wherein the user device prompts a user to reroute based on the selected advertisement.

8. An apparatus comprising:
a communication interface configured to receive, from a user device, a route request for route directions; and
a processor configured to generate an advertisement request for advertisement content and determine the location of the user device and routing information associated with the route directions,
wherein the communication interface is further configured to,
transmit the advertisement request to an advertisement platform configured to select an advertisement based on the location of the user device and the routing information,
receive the selected advertisement, and
transmit the selected advertisement along with the route directions to the user device.

9. An apparatus according to claim 8, wherein the selected advertisement is an audio advertisement.

10. An apparatus according to claim 9, wherein the advertisement is selected based on user profile information.

11. An apparatus according to claim 9, wherein the audio advertisement is presented during execution of route directions based on the location of the device.

12. An apparatus according to claim 9, wherein the user device is a mobile phone.

13. An apparatus according to claim 9, wherein selected advertisements are provided to user devices as part of a global positioning system based navigational service.

14. An apparatus according to claim 9, wherein the user device prompts a user to reroute based on the selected advertisement.

15. A method comprising:
generating, at a user device, a request for routing information, the routing information corresponding to at least route directions;
transmitting the request to a navigational platform; and
receiving the routing information along with advertisement information,
wherein the advertisement information is selected based on location of the user device and the routing information.

16. A method according to claim 15, further comprising:
presenting the routing information and, the advertisement information to a user of the user device based on the location of the device.

17. A method according to claim 15, wherein the advertisement information is audio advertisement information.

18. A method according to claim 15, wherein the advertisement information is further selected based on user profile information and/or the routing information.

19. A method according to claim 15, wherein the user device is a mobile phone.

20. A method according to claim 15, wherein the advertisement information is provided to the user device as part of a global positioning system based navigational service.
